(19) United States
(12) Patent Application Publication
(10) Pub. No.: US 2009/0089114 A1
(43) Pub. Date: Apr. 2, 2009

(54) AUTOGENERATION OF CONFIGURATION ACTIVITIES

(75) Inventors: Lei He, Copenhagen (DK); Finn Rode, Gedved (DK); Torben Andresen, Ballerup (DK)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/865,386

(22) Filed: Oct. 1, 2007

(51) Int. Cl. G06Q 10/00; G06F 17/30

(52) U.S. Cl. 705/7; 705/1

(57) ABSTRACT

An activity generation system helps partners set up an Enterprise Resource Planning (ERP) system by automatically generating a list of configuration activities that partners perform to configure the ERP system. The activity generation system programmatically generates a list of configuration activities and dependencies from the metadata of the ERP system. The activity generation system identifies the data sources associated with the menu items available to the user. For each identified data source, the activity generation system determines whether the data source is related to configuration of the system and creates a configuration activity related to the configuration of that data source.

### BACKGROUND

Enterprise Resource Planning (ERP) refers to the field of integrating most of the data and processes of an organization into a unified system. A typical ERP system uses multiple components of computer software and hardware to achieve the integration. Most ERP systems use a unified database to store data for the various system components. Prior to using an ERP system, most organizations have separate applications for accounting, human resources, and other business functions, with external interfaces between each application for sharing data between applications. The introduction of an ERP system to replace two or more independent applications eliminates the need for external interfaces previously required between these applications and provides additional benefits that range from standardization and lower maintenance (one system instead of two or more) to easier reporting and greater reporting capabilities (as all data is typically kept in one database). ERP systems typically attempt to cover all basic functions of an organization, regardless of the organization's business or charter. For example, ERP systems may cover manufacturing, warehousing, logistics, information technology, accounting, human resources, marketing, payroll, and strategic management. Business, nonprofit organizations, nongovernmental organizations, governments, and other organizations utilize ERP systems.

Microsoft Dynamics AX is an ERP product for small and medium businesses. Like typical ERP applications of this scale, there are numerous configuration activities that a partner (e.g., an administrator in an organization) performs after product installation that configure parameters of the system. For example, one type of parameter is nontransactional data. Transactional data refers to data that is placed into the system as part of the partner's business once the ERP system is up and running, such as orders for products. Nontransactional data, on the other hand, is data that should be set up in the system before transactional data is received, such as customer information, customer types, order types, shipping options, and so forth. Configuration activities prepare the ERP system to manage business transactions for the partner's day-to-day business. In addition, the configuration activities may have dependencies that specify an order in which a user should perform the configuration activities. For example, a partner may have to populate a customer type table before a customer table that depends on the customer types in the customer type table.

In the past, ERP system manufacturers manually generated a list of configuration activities for the partner to perform to configure parameters of the ERP system. The list of configuration activities often missed steps or became out of date over time as the ERP system manufacturer updated and improved the ERP system. Because the list of ERP configuration activities can be very long, it can be difficult for the ERP system manufacturer to produce it and verify its correctness.

### SUMMARY

An activity generation system is described that helps partners set up an ERP system by automatically generating a list of configuration activities that partners perform to configure the ERP system. The activity generation system programmatically generates a list of configuration activities and dependencies from the metadata of the ERP system. The activity generation system may generate configuration activities based on a main menu structure derived from a set of menu items and forms provided by the ERP system. The activity generation system identifies the data sources associated with the menu items available to the user. For each identified data source, the activity generation system determines whether the data source is related to configuration of the system and creates a configuration activity related to the configuration of that data source.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the activity generation system in one embodiment.

FIG. 2 is a display page produced by the user interface component of the activity generation system for starting the automatic generation of activities in one embodiment.

FIG. 3 is a flow diagram that illustrates the processing of the configuration table identification component of the activity generation system in one embodiment.

FIGS. 4a-4c illustrate tables and dependencies within the ERP store that create activity dependencies.

FIG. 5 is a block diagram that illustrates the activity dependencies created by the activity generation system for the example tables of FIGS. 4a-4c.

FIG. 6 illustrates three data structures for storing activity information generated by the activity generation system.

### DETAILED DESCRIPTION

### Overview

An activity generation system is described that helps partners set up an ERP system by automatically generating a list of configuration activities that partners perform to configure the ERP system. The activity generation system programmatically generates a list of configuration activities and dependencies from the metadata of the ERP system. For example, the metadata may include database schema including tables, fields, types of fields, foreign key relationships, and so forth. The activity generation system may generate the list of configuration activities based on a main menu structure derived from a set of menu items and forms provided by the ERP system. For example, an ERP system may present a main menu to the user that identifies the actions that the user can perform with the ERP system. The activity generation system uses the menu items to identify the data sources (e.g., tables) affected when the user invokes the menu item. For example, invoking a menu item may display a form that populates a particular table of the ERP system. In this example, the activity generation system identifies the form associated with the menu item and then the table associated with the form. For each identified data source, the activity generation system determines whether the data source is related to configuration of the system and if so, creates a configuration activity related to the configuration of that data source. For example, if a table contains nontransactional data and receives information from a form displayed to the user, then the activity generation system may identify the table as related to configuration and create a configuration activity that reminds the user to populate the table with data. The activity generation system combines the created activities to generate a list of configuration activities to display to the partner. Thus, the activity generation system automatically builds a list of configuration activities for configuring the ERP system. In addition, the activity generation system can easily rebuild the list of configuration activities whenever the ERP system changes to keep the list of configuration activities up to date.

The activity generation system identifies configuration parameters by tracing the functionality of menu items, identifying dependencies associated with the menu items, and applying any exceptions. Each of these processes, described in further detail below, depends on examining the storage format of the ERP system to identify relevant data elements and determine whether the elements relate to configuration of the ERP system. The following section describes the ERP system storage format in one embodiment.

### ERP System Storage Format

An ERP system often stores elements of the ERP system in a database. For example, an Application Object Tree (AOT) may contain metadata of the ERP system that describes forms, reports, and other elements that make up the ERP system. In some embodiments, each configuration activity is associated with a specific setup form of the ERP system. For example, a configuration activity for adding customer groups may be associated with an “Add Customer Group” form. The activity generation system may generate the list of configuration activities by identifying the forms stored by the ERP system and determining whether those forms are related to configuration. If so, then the activity generation system creates a configuration activity related to populating the data source associated with the form.

In some embodiments, the activity generation system identifies configuration parameters based on metadata stored within the AOT. For example, tables in the AOT may have a table type specified by a “tableGroup” property. The system may use the metadata in part to categorize tables according to their purpose. For example, the tableGroup property may have a value of “transactional data” for tables related to ecommerce transactions and a value of “configuration” for tables related to configuration of the ERP system.

### Form Tracking

In some embodiments, the activity generation system identifies configuration parameters by identifying forms that populate data in the ERP system. Interactive or manual configuration that requires user interaction is often performed by using a main menu or other user interface entry point provided by the ERP system that has an associated form. The form for a displayable menu item typically has an underlying nontransactional data table as its primary source of data. The activity generation system can determine the table associated with a form programmatically (e.g., by using SQL or other database access languages). When a data source is identified, the activity generation system creates a configuration activity related to populating the data source. In addition, the activity generation system can determine logical divisions with which to categorize the created configuration activities based on the menu item information. For example, the main user interface may divide tasks for accounting, human resources, engineering, and so forth, and the activity generation system can create categories of configuration activities having similar divisions. If there are multiple menu paths to a display menu item, the activity generation system creates only one configuration activity (e.g., the first reference in the main menu tree).

### Dependencies

In some embodiments, the activity generation system identifies dependencies between configuration activities. A dependency is the constraint that an activity A1 has to be performed before another activity A2 because the data set up by A2 depends on the data set up by A1. A1 is then referred to as the predecessor activity, while A2 is referred to as the successor activity. The activity generation system can identify dependencies by examining “relations” defined in the AOT among nontransactional tables. For example, the AOT may contain a Customer table, a Vendor table, and a Price Group table. The Customer table lists customers of the partner using the ERP system, the Vendor table lists vendors that supply parts for the partner, and the Price Group table describes different pricing tiers that apply to either customers or vendors. The Customer and Vendor tables contain a field that specifies a price group, and this field has a relationship to the Price Group table.

In some embodiments, the activity generation system considers field types in a table to determine whether the table contains configuration data. In the previous example, the price groups are user-defined (e.g., by the partner), and the price group field is referred to as an Extended Data Type (EDT). Many configuration activities interact with user-defined EDTs, and the presence of an EDT is one possible indicator of configuration data.

In some cases, nontransactional data related to separate configuration activities is stored in the same table(s). The Price Group table in the previous example stores information related to the Vendor table and to the Customer table. The ERP system may have separate menu items for populating the Customer and Vendor tables, and the activity generation system may create a separate configuration activity for populating each of these tables. In some cases, the data in the Price Group table contains a field that separates the data that relates to customers from the data that relates to vendors. For example, the table may contain an enumeration field that is set to one for price groups that relate to customers and is set to two for price groups that relate to vendors. When the activity generation system creates configuration activities for the Customer and Vendor tables, the system identifies the dependency on the Price Group table and stores the information about the enumeration value related to each table.

### Exceptions

In some embodiments, the activity generation system does not generate activities for certain identified ERP system elements. For example, some types of ERP data, such as journals and inquiries are transactional data, and the activity generation system excludes their setup from the generated list of activities even if the tableGroup or other properties otherwise satisfy the rules described herein. As another example, some menu items are excluded from activity generation based on domain knowledge. For example, an accounting menu item of an ERP system may have elements that are not typically configured when the ERP system is initially set up, and these elements will not be included as activities in the activity list. As another example, if the user that invoked the activity generation system does not have write permission to a particular non-transactional table or the table is not editable, then the activity generation system may skip activities for that table.

### Classes

In some embodiments, the activity generation system is implemented as a runable class rctActivityGenerate. The class rctActivityGenerate is the class that carries out the activity generation process described herein. It extends from the runbase class and has a main method, which allows it to be run from the AOT. Following are descriptions of the major methods of the rctActivityGenerate class:

Static void main(args_args)
Brings up the dialog to set parameters and then calls the run( ) method to kick off the
workflow.
Void run( )
Drives the activity and dependency generation flow. The method contains two parts: 1) if
“generate dependency only” is false, the method loops and traverses through the main
menu and processes all menu items, tracking context information (the current menu
object) and creating business domain IDs as it goes, and 2) the method generates
dependencies among the generated activities. Table writes are enclosed in a transaction.
Errortxt doMenuItem(menuitem_menuitem)
Processes activity generation for a discovered menu item, inserting an activity into the
rctActivity table if a qualifying activity is found for the given menu item. This method is the
main work method for activity generation. Given a menu item, the underlying data source
(e.g., a table) is retrieved. If the table has the right tableGroup property, table access
permission is checked, exception logic is applied (e.g., inquiries and journals are
excluded), and an activity is created and inserted into the rctActivity table.
Void findPred( )
Finds the predecessors of the activities stored in the map of activities to table IDs
(actIds2tablIds). If the option “generate dependencies only” is checked, it means that the
activities are already created, so it reads the activities from the rctActivity table and
constructs the map. The logic of finding the data source table of a menu item is similar to
that in doMenuItem. It then loops through the map and calls findPredTables( ) to find the
dependencies for each activity.
Void findPredTables(rctActivityId_actId, tableId_tableId)
Creates dependencies for a given activity, inserting dependency records into the
rctActivityDependency table. This method is the main work method for dependency
generation. For each table that is associated with an activity, the method loops through
the fields to look for nonsystem fields that have relations defined for their underlying EDT
(i.e., that has a foreign key reference to another parent table). If the relation is a single
line definition of a field looking up a field of a parent table, the parent table is mapped
back to its associated activity and the dependency is inserted. If the relation is a complex
definition of multiple lines, with the lookup partitioned by different values in a field in the
parent table (usually an enum), then the method calls a helper function to find the right
predecessor by matching the enum value. In other cases where there are multiple
matches, the method further matches by first matching the formRef property of the
underlying nontransactional table and then matching the business domain ID.

### Figures

The following figures illustrate the features of the activity generation system described above through several examples.

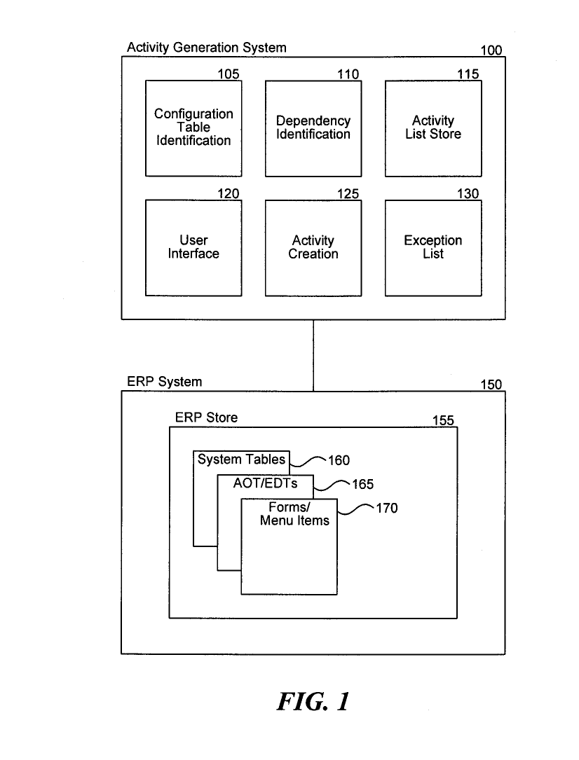

FIG. 1 is a block diagram that illustrates components of the activity generation system in one embodiment. The activity generation system 100 contains a configuration table identification component 105, a dependency identification component 110, an activity list store component 115, a user interface component 120, an activity creation component 125, and an exception list component 130. The activity generation system 100 communicates with an ERP system 150. The ERP system contains an ERP store 155, which contains system tables 160, an AOT having EDTs 165, and forms/menu items 170.

The configuration table identification component 105 uses rules to traverse the ERP store 155 to identify tables, forms, or other elements related to configuration of the ERP system 150. Configuration tables are generally associated with user-visible menu items 170. When the configuration table identification component 105 identifies menu items 170 in the ERP store 155, the configuration table identification component 105 identifies related tables and EDTs 165 associated with the menu items 170. The dependency identification component 110 identifies dependencies within the configuration tables. For example, a customer table may depend upon a customer type table. The activity creation component 125 creates activities based on the identified configuration tables and dependencies. The activity creation component 125 stores the created activities in the activity list store component 115. The user interface component 120 operates at the beginning of the activity generation process to receive information from the user about how the activity generation system 100 should generate activities. The user interface component 120 may also provide a display or data file that contains the activity list that results from the activity generation process. The exception list component 130 optionally contains a list of exceptions to the rules used by the configuration table identification component 105. For example, certain table types may be excluded from activity creation, even though the tables would otherwise satisfy the rules.

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

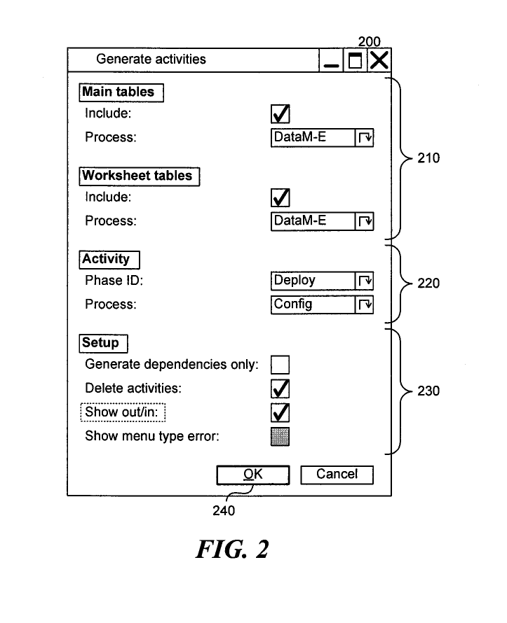

FIG. 2 is a display page produced by the user interface component of the activity generation system for starting the automatic generation of activities in one embodiment. The display page 200 contains a region 210 for selecting the tables to include when identifying configuration activities. For example, the user can select main tables and worksheet tables. The display page 200 also contains a region 220 for a user to configure the types of activities that the activity generation system will generate. For example, the activity generation system can generate a list of configuration activities suitable for partners who deploy the ERP system in their organizations. The display page 200 also contains options 230 that the user can select to modify how the activities are generated. For example, one option allows the user to only generate dependencies. When the user selects an OK button 240, the activity generation system begins identifying activities based on the user's selections.

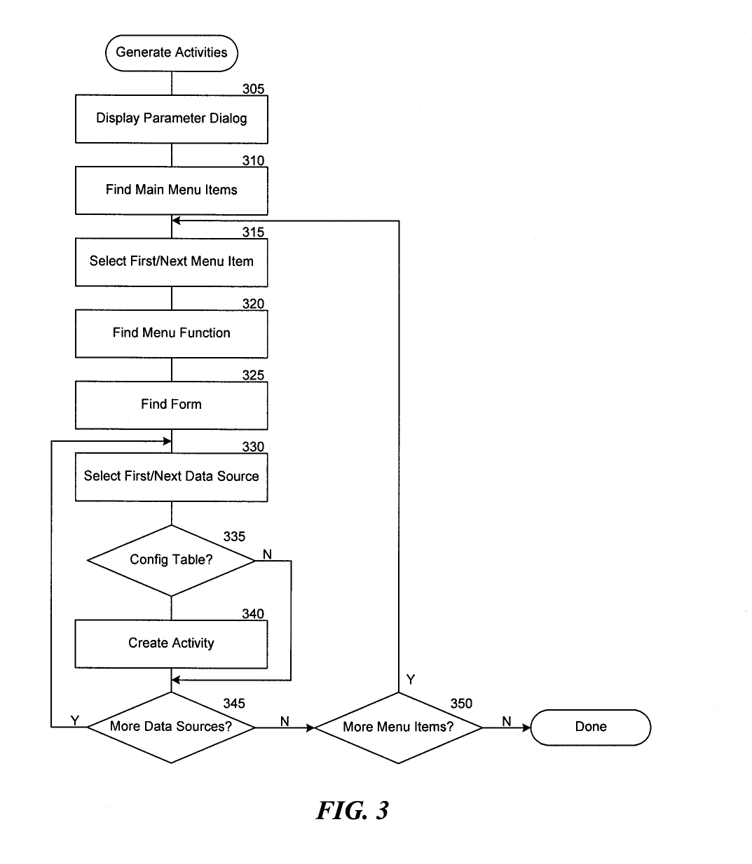

FIG. 3 is a flow diagram that illustrates the processing of the configuration table identification component of the activity generation system in one embodiment. In block 305, the component displays a display page for setting parameters that configure how activities are generated. For example, the component may display the display page of FIG. 2. In block 310, the component finds the main menu and related menu items in the ERP store. For example, the component may search a database of ERP system elements to identify the interface first displayed to the user when the ERP system starts. In block 315, the component selects the first menu item in the main menu. For example, the component may iterate through a table of menu items. In block 320, the component locates the function performed by the menu item when a user selects the menu item in the user interface. In block 325, the component identifies the form associated with the menu function and the data sources associated with the form. For example, the form may reference one or more tables in the database. In block 330, the component selects the first data source associated with the form. In decision block 335, if the selected data source is related to configuration, then the component continues at block 340, else the component continues at block 345. In block 340, the component creates an activity that describes the way in which a user would populate the data source. For example, the component may enumerate the fields in the table and generate an activity that describes the information requested by each field. The component may also identify dependencies (not shown) related to the data source, such as foreign key or other relationships within the database. In decision block 345, if there are more data sources associated with the menu item form, then the component loops to block 330 to select the next data source, else the component continues at block 350. In decision block 350, if there are more menu items associated with the main menu, then the component loops to block 315 to select the next menu item, else the component completes. After block 350, these steps conclude.

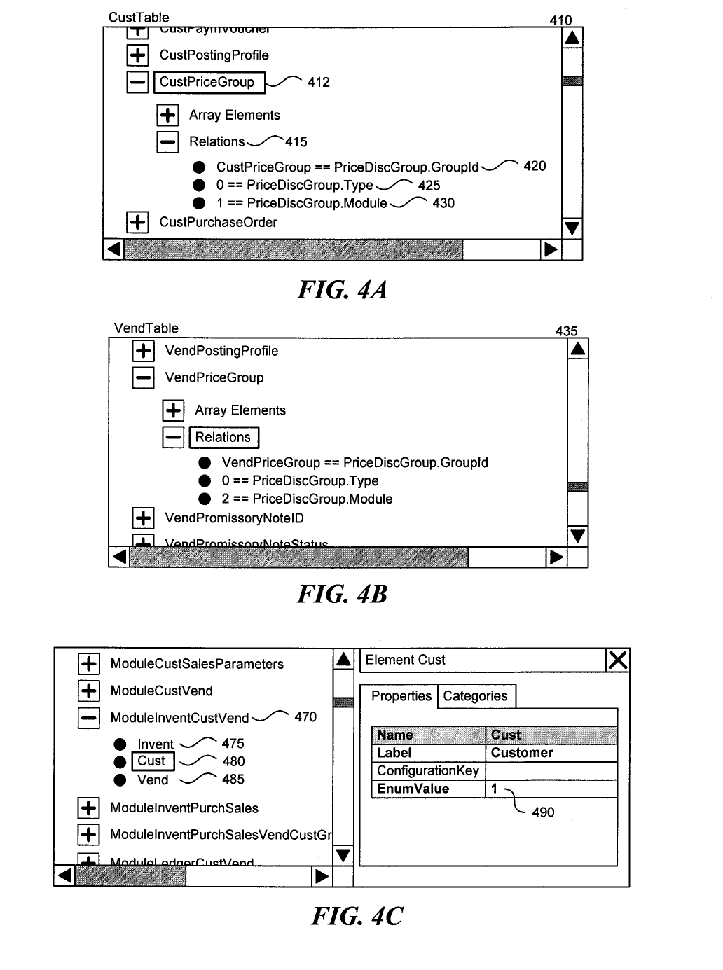

FIGS. 4a-4c illustrate tables and dependencies within the ERP store that create activity dependencies. A CustTable table 410 contains customer information. One field of information is a CustPriceGroup field 412 that identifies a pricing group to which a particular customer belongs. For example, there may be retail and wholesale price groups. The CustPriceGroup field 412 is an example of an EDT created by a user. A Relations node 415 identifies relationships for the CustPriceGroup field 412. A first relationship 420 indicates that the CustPriceGroup field 412 contains an identifier that matches an identifier in a GroupId field of a PriceDiscGroup table. Thus, before populating the CustPriceGroup field 412 of the CustTable table 410, the user should populate the PriceDiscGroup table. A second relationship 425 indicates that only values of zero in the PriceDiscGroup table for a Type field are related to the CustPriceGroup field 412. In addition, a third relationship 430 indicates that only values of one in the PriceDiscGroup table for a module field are related to the CustPriceGroup field 412. FIG. 4b illustrates a similar set of relationships between a VendTable table 435 and the PriceDiscGroup table.

FIG. 4c illustrates the definition of the enumeration used to specify the module field for FIGS. 4a and 4b. The ModuleInventCustVend enumeration 470 contains an Invent value 475, a Cust value 480, and a Vend value 485. Each enumeration value contains an associated numeric value. For example, the Cust value 480 has a numeric value 490 of one. The numeric value is referenced in FIGS. 4a and 4b where the numeric values one and two appear for the PriceDiscGroup.Module field.

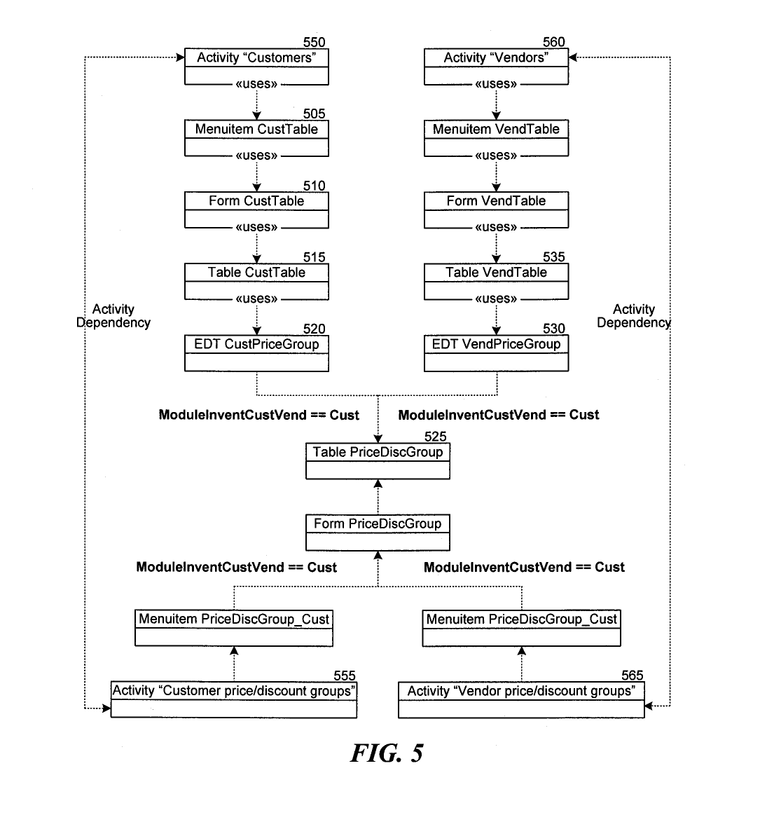

FIG. 5 is a block diagram that illustrates the activity dependencies created by the activity generation system for the example tables of FIGS. 4a-4c. A CustTable menu item 505 is related to a CustTable form 510. The CustTable form 510 is related to a CustTable table 515 that acts as a data source for the form. The CustTable table 515 contains a CustPriceGroup EDT 520 that is related to a PriceDiscGroup table 525 as described in FIG. 4a. Similarly, a VendPriceGroup EDT 530 is also related to the PriceDiscGroup table 525 as described in FIG. 4b. The activity generation system creates an activity 550 for populating the CustTable table 515 and another activity 560 for populating a VendTable table 535. In addition, the activity generation system creates activities 555 and 565 for populating the various types of customer price groups and vendor price groups. The activity generation system makes the customer table activity 550 dependent on the customer price group activity 555 and makes the vendor table activity 560 dependent on the vendor price group activity 565.

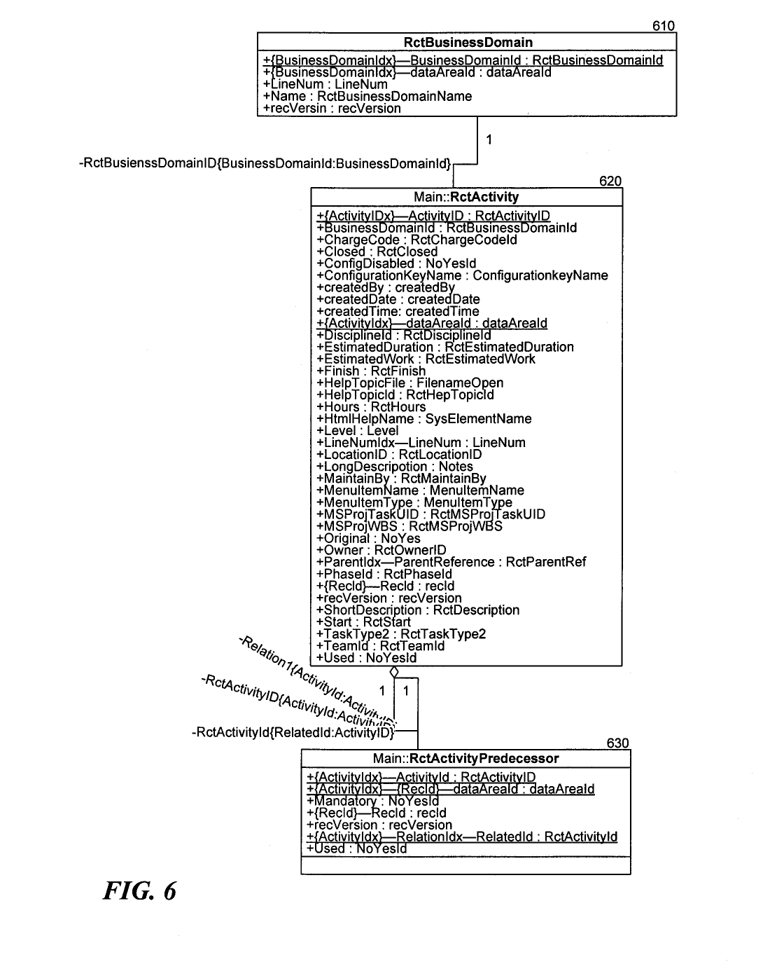

FIG. 6 illustrates three data structures for storing activity information generated by the activity generation system. The activity generation system may store output in a database or other data store that is familiar to administrators of an ERP system. For example, the activity generation system may store information in a business domain table 610 that describes the different categories of activities that are identified by the activity generation system. The activity generation system may also store information about each created activity in an activity table 620. The activity table 620 may contain fields, such as a Closed field 625 that indicates whether the activity has been completed. The activity generation system may also store data in an activity predecessor table 630 that describes dependencies among activities. For example, the activity predecessor table 630 may identify each predecessor and successor activity so that a user can perform activities in an appropriate order.

### CONCLUSION

From the foregoing, it will be appreciated that specific embodiments of the activity generation system have been described herein for purposes of illustration, but that various modifications may be made without deviating from the spirit and scope of the invention. For example, although ERP systems have been described, the techniques described herein are equally applicable to other types of situations that receive post-installation configuration information from a user. Accordingly, the invention is not limited except as by the appended claims.

I/We claim:

1. A method of producing a list of configuration activities for completing the setup of a customer system, the method comprising:
identifying a displayable indication of the customer system;
determining that the displayable indication is for receiving configuration information from a user;
identifying a data source associated with the displayable indication; and
creating one or more configuration activities to remind the user to populate the data source.

2. The method of claim 1 wherein determining that the displayable indication is for receiving configuration information comprises determining a type of the data source associated with the displayable indication.

3. The method of claim 1 wherein the displayable indication is a menu item in a user interface.

4. The method of claim 1 wherein the displayable indication is a form for interacting with a database.

5. The method of claim 1 wherein the data source is a database table.

6. The method of claim 1 including identifying a dependency between a first configuration activity and a second configuration activity.

7. The method of claim 1 including categorizing the configuration activities based on the displayable indication to which the configuration activity is related.

8. A system for automatically generating configuration instructions based on the data requirements of an ERP system, comprising:
a configuration table identification component configured to identify one or more tables that receive configuration information from a user;
an activity creation component configured to create configuration instructions based on the identified configuration tables; and
a user interface component configured to display a list of configuration instructions to a user, wherein the list of configuration instructions identifies activities to be completed by the user before using the ERP system.

9. The system of claim 8 including an activity list store component configured to store the created configuration instructions.

10. The system of claim 8 including a dependency identification component configured to identify dependencies between identified configuration tables.

11. The system of claim 10 wherein the user interface component displays activities in an order based on the identified dependencies.

12. The system of claim 8 including an exception list component configured to store exceptions used to exclude certain tables from the creation of activities.

13. A computer-readable medium encoded with instructions for controlling a computer system to update configuration operations for customizing an ERP system, by a method comprising:
modifying the ERP system to include a new feature that operates with configuration information from a user;
receiving a request to update a list of configuration operations, wherein the list of configuration operations describes the existing features of the ERP system that operate with configuration information from the user;
enumerating at least some of the elements of the ERP system;
automatically determining based on the enumerated elements that the new feature operates with configuration information from the user; and
updating the list of configuration operations to include an activity related to providing the configuration information related to the new feature.

14. The computer-readable medium of claim 13 wherein modifying the ERP system includes adding a new table to the ERP system.

15. The computer-readable medium of claim 13 wherein receiving a request to update a list of configuration operations comprises displaying a user interface to the user.

16. The computer-readable medium of claim 13 wherein enumerating elements of the ERP system comprises identifying at least one menu item of the ERP system.

17. The computer-readable medium of claim 13 wherein enumerating elements of the ERP system comprises identifying at least one table of the ERP system.

18. The computer-readable medium of claim 13 wherein automatically determining comprises identifying a type of at least one enumerated element.

19. The computer-readable medium of claim 13 wherein automatically determining comprises determining that an enumerated ERP system element is associated with a main menu of the ERP system.

20. The computer-readable medium of claim 13 wherein automatically determining comprises identifying a business domain of the enumerated ERP system elements.
